(19) United States
(12) Patent Application Publication
(10) Pub. No.: US 2013/0235265 A1
(43) Pub. Date: Sep. 12, 2013

(54) VIDEO DISPLAY SYSTEM

(71) Applicant: Adam DAVIS, Leola, PA (US)

(72) Inventor: Adam DAVIS, Leola, PA (US)

(73) Assignee: TAIT TECHNOLOGIES, INC., Warrdamme (BE)

(21) Appl. No.: 13/543,223

(22) Filed: Jul. 6, 2012

(30) Foreign Application Priority Data
Mar. 8, 2012 (BE) 2012/0153

(51) Int. Cl. H04N 9/12

(52) U.S. Cl. 348/383; 348/E09.012

(57) ABSTRACT

A video display system includes a substantially horizontally positioned activity area. A plurality of modules is operatively associated with the activity area and is arranged to form a display area, each of the modules including at least one light source. The modules cooperatively display light to display at least one of video and images.

### FIELD OF THE DISCLOSURE

The present disclosure relates to display systems. More specifically, the present disclosure relates to video display systems associated with substantially horizontally positioned activity areas.

### BACKGROUND OF THE DISCLOSURE

Electronic displays for use in advertising are well known in the art. Such electronic displays find use in advertising applications in a variety of environments. In recent years, flat-panel display technologies have been developed, such as plasma, LCD, LED and other types of vertically mounted displays, such as may be used in forming billboards or secured to vertically extending structures or vertically suspended from such structures for use with other public venues.

However, known video displays, particularly for advertising on billboards and similar structures, have previously been limited to vertical mounting arrangements. In a public performance venue held in a structure having an elevated viewing area that surrounds the venue, e.g., forming a closed circular or oval shape, even a large, single vertically mounted display area suffers from the drawback that it could typically not be simultaneously viewable by substantially all of the audience; requiring multiple displays.

Therefore, there is an unmet need to provide a system having a display area that is viewable by substantially all of a similarly situated audience viewing a public performance.

### SUMMARY OF THE DISCLOSURE

One aspect of the disclosure includes a video display system including a substantially horizontally positioned activity area. A plurality of modules operatively associated with the activity area is arranged to form a display area, each of the modules including at least one light source. The modules cooperatively display light to display at least one of video and images.

A further aspect of the disclosure includes a method of displaying video. The method includes providing a video display system having a substantially horizontally positioned activity area and a plurality of modules associated with the activity area and being arranged to form a display area, each of the modules including at least one light source. The method includes cooperatively displaying light with the modules to display at least one of video and images.

An advantage of the present disclosure is that the video display system is portable and re-usable.

Another advantage of the present disclosure is a video display system having modules that resemble the surrounding surface of the activity area when the system is not in operation.

It is to be understood that one or more of the above-referenced advantages may be contained in an exemplary embodiment of the present disclosure.

Further aspects of the method and system are disclosed herein. The features as discussed above, as well as other features and advantages of the present disclosure, will be appreciated and understood by those skilled in the art from the following detailed description and drawings.

### BRIEF DESCRIPTION OF THE DRAWINGS

FIG. 1 shows a perspective view of an exemplary embodiment of a video display system.

FIG. 2 shows an enlarged, partial perspective view of the exemplary embodiment of FIG. 1 of a video display system.

FIG. 3 shows a plan view of another exemplary embodiment of a video display system.

FIG. 4 shows a perspective view of a module of a video display system according to an embodiment.

FIG. 5 shows a perspective view of a module of a video display system according to an embodiment.

FIG. 6 shows an enlarged, partial perspective view of an exemplary embodiment of FIG. 1 of a video display system.

FIG. 7 shows a cross section taken along line 7-7 of FIG. 6 of an embodiment of a video display system.

FIG. 8 shows a cross section taken along line 7-7 of FIG. 6 of another embodiment of a video display system.

FIG. 9 shows a cross section similar to that taken along line 7-7 of FIG. 6 of yet another embodiment of a video display system.

FIG. 10 shows a plan view of another exemplary embodiment of a video display system.

FIG. 11 shows a cross section taken along line 11-11 of FIG. 10 of an embodiment of a video display system.

### DESCRIPTION OF THE DISCLOSURE

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

What is provided are video display systems formed in substantially horizontal activity areas, such as base structures or floors of public venues, for example, sports stadiums for advertising, informational or other applications.

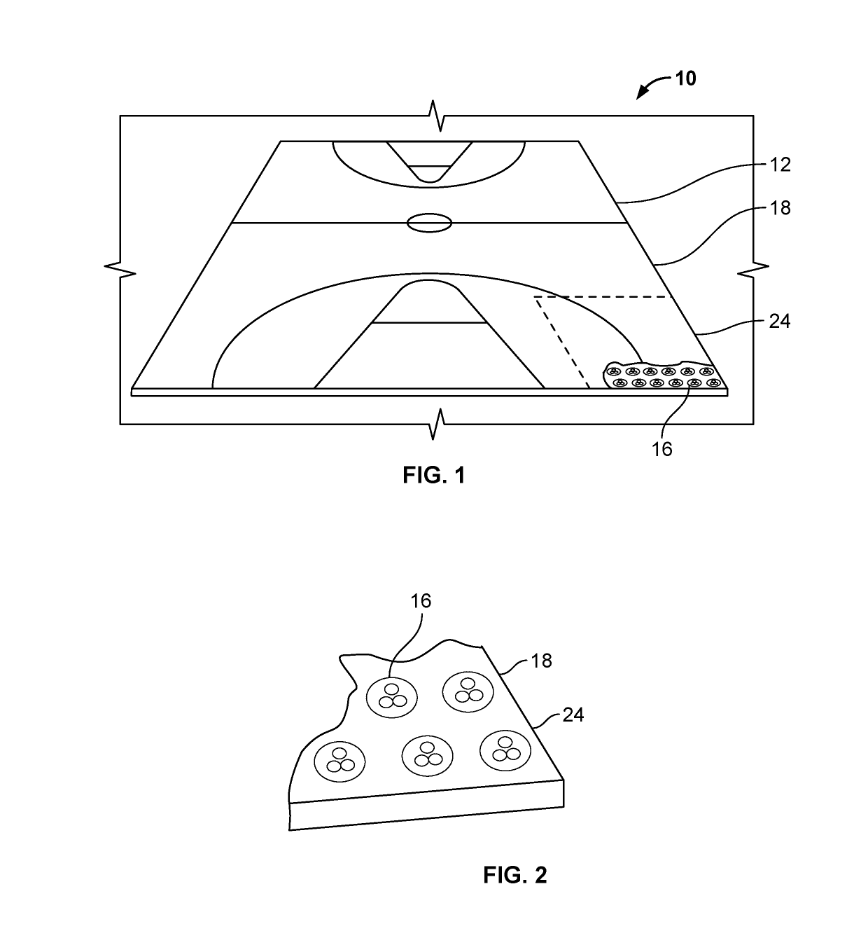

FIG. 1 illustrates one embodiment of a video display system 10. The video display system 10 includes a plurality of modules 16 operatively associated with an activity area 12 associated with a public performance. Without intending to be limiting, a public performance may include athletic performances, cultural performances, entertainment performances and combinations thereof. In other words, a public performance is intended to include any basis for a public gathering. As further shown in FIG. 1, activity area 12 is a basketball court, normally having a substantially horizontal, planar surface contained within the boundary lines of the basketball court. However, modules 16 may be arranged together on or within (FIG. 2) activity area 12 to form a display area 18 that may encompass one or more portions of the activity area. In one embodiment, display area 18 may substantially coincide in areal size and/or profile or shape with activity area 12, although in another embodiment, the display area may be larger in areal size than the activity area. That is, with respect to FIG. 1, display area 18 may extend outside of the borders of the basketball court. Modules 16 forming display area 18 may be arranged in a low-resolution or high-resolution video configuration.

In another embodiment, it is to be understood that the activity areas may also include non-horizontal regions, such as portions of stairs, or multi-level stages, including interconnecting structures, such as ramps that may be associated with a public performance, such as a stage associated with a musical performance. In addition, such non-horizontal regions may extend above or below adjacent or surrounding portions of the activity area. In one embodiment, display area 18 is an area of sufficient size to be viewable at some distance from the video display system, such as at least the distance from which an audience member could normally view the activity area. In one arrangement, for purposes of an enclosed or substantially enclosed structure, such as a stadium, the distance could be associated with seating or other regions capable of being occupied by an audience, such as “standing room only” sections that are positioned at the greatest distance from the activity area within the stadium.

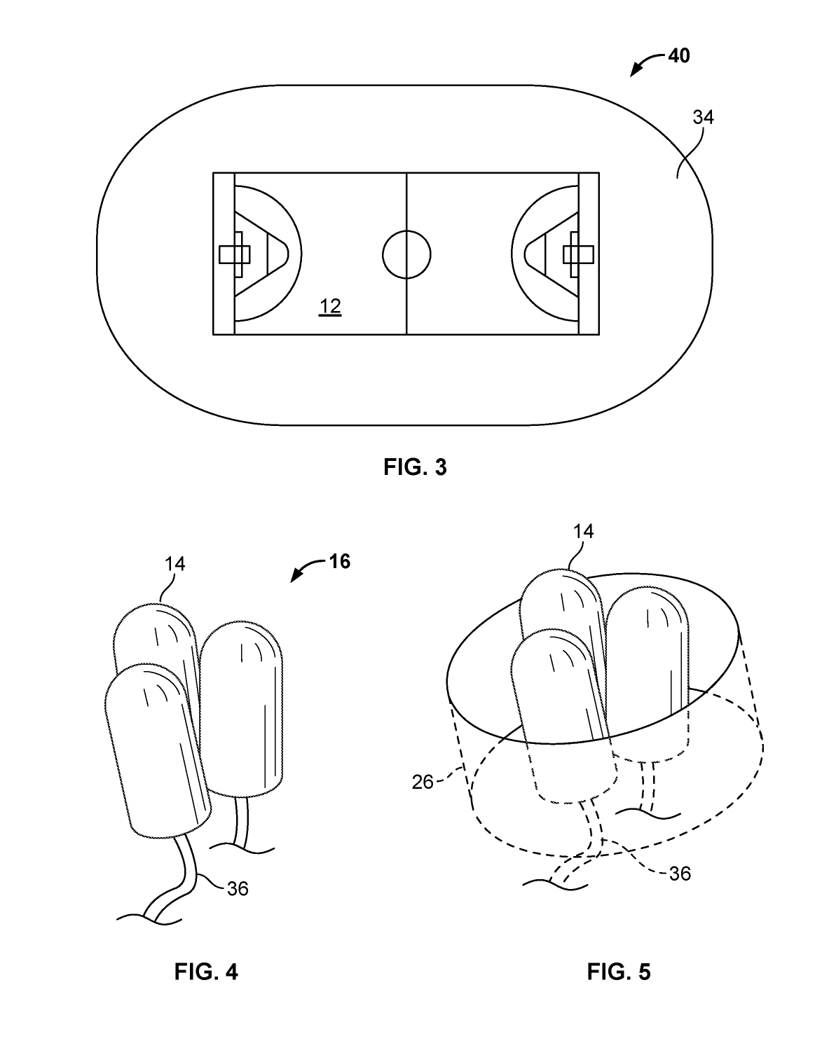

The size of sports stadiums has continued to increase, the largest currently having a circular footprint of 207,000 square meters (1,684 feet in diameter). Alternately, structures 40 or stadiums with seating 34 surrounding activity area 12 may be non-circular, such as oval as shown in FIG. 3, having distances from the activity area which may or may not be greater than comparably sized stadiums or structures configured it for public performances. Accordingly, the display area would desirably be sufficiently large to be viewable from distances approaching, if not exceeding that of the largest highway signs, which signs being viewable from distances from up to about 500 feet or up to about 2,500 feet.

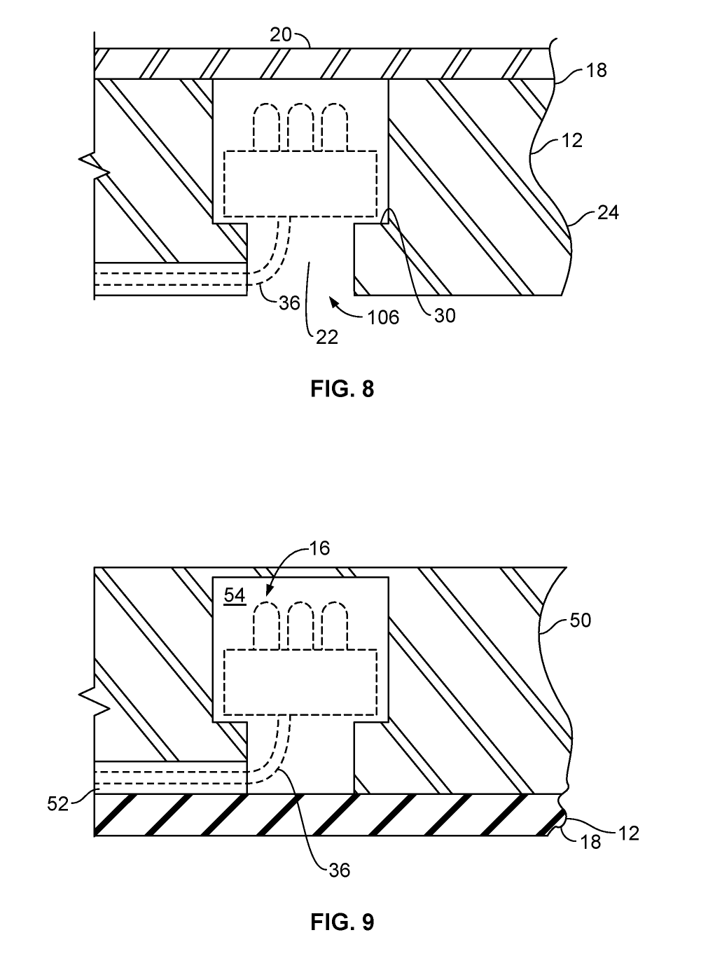

Modules 16 include one or more colored light sources 14 (FIGS. 4-5), such as light emitting diodes (LEDs). In one embodiment, such as further shown in FIG. 4, colored light sources include a grouping of red, green and blue LEDs, although in other embodiments, different numbers and colors of light sources may be used, if desired. The light sources 14 may be controlled by any suitable control means (not shown) known in the art for providing images and/or video. The light sources may include, for example, organic light emitting diodes (OLEDs), incandescent bulbs, fluorescent bulbs, polymer light emitting diodes, electroluminescent lights, other suitable light emitting sources, and/or a combination of light emitting units. Modules 16 may be provided as individual elongate units or may be units of alternate geometries or groupings of units, such as contained in a housing 26 (FIG. 5) that provide the desired visual, video or combined effect. Modules 16 can be individually or collectively secured to activity area 12 (FIG. 9), such as by containing module 16 inside a layer or shield 50, which shield overlying the activity area. Alternately, modules 16 may be formed inside of activity area 12 (FIGS. 7-8).

As shown in the figures, modules 16 are preferably in communication with each other and controlled by a single controller or a series of controllers, which coordinate display area 18. Modules 16 may be connected to each other and/or the controller by any suitable means, including, but not limited to, wired connections 36 (FIGS. 4-5) or wireless connections. In one embodiment, video or image information may be transmitted to modules 16 to provide the desired visual display. Video display system 10 may use video signals, image signals, controllers and the control systems known in the art for providing video and/or images to LED systems.

The control of modules 16 may be provided by the same controller or may be provided by one or more controllers and may comprise or include a computing device.

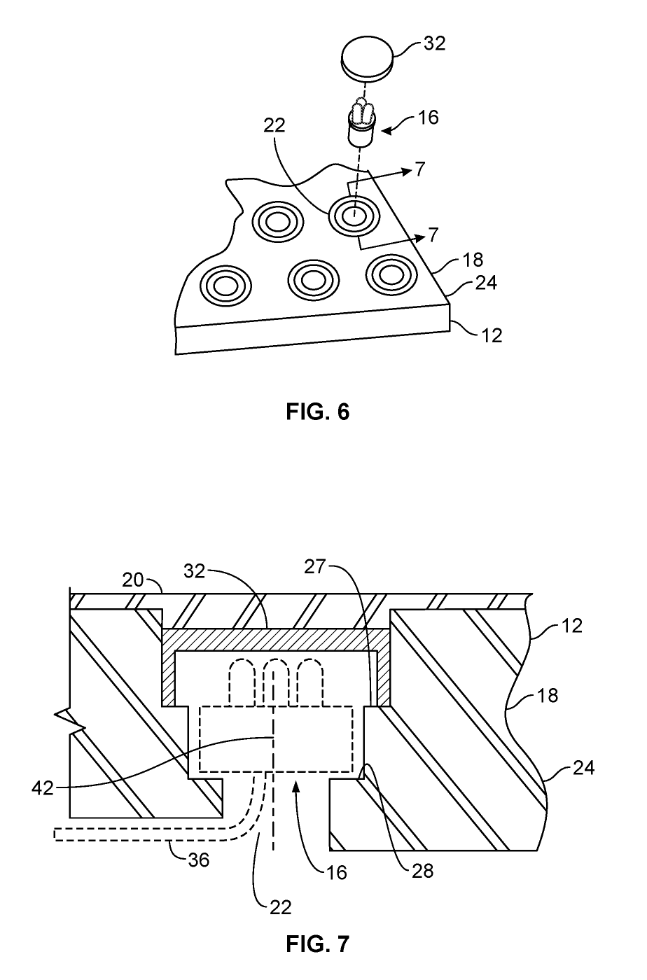

FIGS. 6-8 show exemplary arrangements of modules 16 operatively associated with display area 18 of activity area 12. As shown in FIG. 7, an aperture 22, such as a plurality of substantially aligned openings of different sizes having a common center axis 42, also commonly referred to as a counterbore, may be formed through display area 18. As further shown in FIG. 7, adjacent openings formed in aperture 22 define shoulders 27, 28. For example, shoulder 28 supports module 16 inside of activity area 12. In addition, shoulder 27 supports a transparent cover 32 positioned above cover 32. Cover 32 is preferably a rigid substantially transparent material capable of protecting the modules 16 mounted underneath. Suitable materials for fabricating cover 32 include, but are not limited to, plexiglass, glass, polymeric and other substantially rigid transparent or semi-transparent material. In one embodiment, cover 32 is configured to resemble the surrounding surface of activity area 12 when video display system 10 is not in operation. That is, when the video display system is not being used, it may be desirable for covers 32 to blend with and substantially hide modules 16, as desirable. As further shown in FIG. 7, cover 32 is recessed with respect to a surface of the surrounding area of display area 18 of activity area 12. While not so limited, cover 32 is preferably maintained at a position above the light source 14 that provides a gap sufficient to provide cooling for the light source and to provide an aesthetically pleasing view of the display provided by the modules 16. In addition, the substantially transparent cover may be fabricated to seal the modules from exposure to environmental conditions, particularly in outdoor applications.

As yet further shown in FIG. 7, substantially transparent shield 20 overlies at least a portion, if not the entire surface, of display area 18 of activity area 12. In one embodiment, in which activity area 12 is primarily associated with athletic performances, such as a basketball court, shield 20 may be applied directly onto the surface of display area 18. Shield 20 may be a varnish or lacquer or other suitable material, whether applied onto the surface of display area 18 in liquid or a roll of material requiring further processing, ultimately resulting in a virtually planar surface that would provide substantially uniform structural properties along the entire surface of activity area 12, as would be required of a high quality basketball court (or of the surface of the current athletic/entertainment performance of interest).

As yet further shown in FIG. 8, substantially transparent shield 20 overlies at least a portion, if not the entire surface, of display area 18 of activity area 12. In one embodiment, in which activity area 12 is primarily associated with athletic performances, such as a basketball court, shield 20 may be applied directly onto and bonded with the surface of display area 18. As further shown in FIG. 8, aperture 106 includes adjacent openings formed in activity area 12, the juncture between adjacent openings defining shoulder 30 for supports module 16. A cover, such as cover 32 in FIG. 7, is not provided in the embodiment of FIG. 8.

As shown in FIG. 9, modules 16 can be individually or collectively secured to activity area 12 (FIG. 9), such as by containing module 16 inside a layer or shield 50, which shield overlying the activity area. Modules 16 may be positioned inside of pockets 54 formed in shield 50. Grooves 52 are formed in shield 50, as required, to permit wired connections 36 to extend between shield 50 and display area 18 of activity area 12.

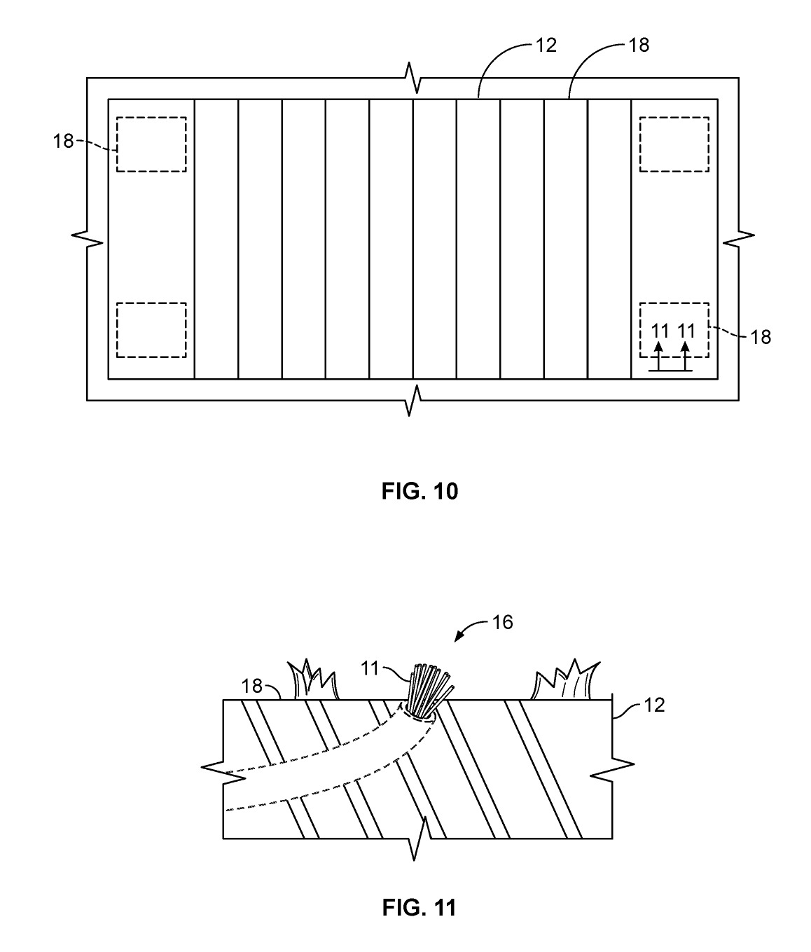

FIG. 10 shows an activity area 12 that resembles a football field, also referred to as a gridiron. As further shown in FIG. 10, display areas 18 are shown corresponding to corners of the football field. It is to be understood that the display areas are not limited to these locations. As further shown in FIG. 11, display area 18 of activity area 12 may include a module composed fiber optic tubes 11. Fiber optic tubes 11 each containing a plurality of filaments may utilize LEDs as a light source, or other suitable light source. Tubes 11 should be of substantially the same color, or be substantially transparent as the grass or turf of the activity area such as to blend in with the surrounding tufts of grass or turf of the activity area or be concealed or camouflaged from view by the audience when the system is not in operation. In another embodiment, display area 18 may encompass the entire area of the football field. It is to be understood that the activity area can include other indoor/outdoor grass or turf activity areas, including, but not limited to, soccer fields, rugby fields, baseball fields, raceways, such as raceway regions inside the race tracks, commonly referred to as “infields”, or in another embodiment, modules could be formed in at least portions of the track itself.

It is to be understood that irrespective the installation of the activity area, whether the activity area represents a permanent, non-removeable installation, or represents an activity area that may be portable, frequently removed/re-installed in portions, such as is the case with multi-purpose facilities. For example, portion 24 (FIG. 1) of activity area 12 includes features formed in or applied to the opposed surface of the activity area or applicable portions thereof, such as grooves, connections, conductive spray coatings applied to underside of portions so as to be compatible with connections 36, such as wire connections of modules 16 of the video display system.

In another embodiment, connections 36 may include power and/or signal functionality. For example, connections 36 may be one or more communication and/or power providing cables, such as fiber optic or copper-based wires or cables, or Ethernet cables.

In yet another embodiment, connections 36 may be wires, such as power cords, run along-side cables and connected to a controller (not shown). In one embodiment, the wires and the cables may be integrated. In another embodiment, the wires may be integrated by being circumferentially bounded by cables, providing structural support.

Modules 16 can be one or more light emitting devices. For example, the light emitting devices may be light emitting diodes (LEDs) housed within a housing that may be transparent, translucent, semi-transparent, semi-translucent, or a combination thereof. In one embodiment, the LEDs may be configured to emit colored light based upon a signal from controller (not shown). In another embodiment, the modules 16 may emit a single color of light. In another embodiment, the modules 16 may emit multiple colors of light simultaneously or at different times. In yet another embodiment, multiple LEDs may be housed within the same module 16. In yet another embodiment, with the multiple LEDs housed in the same modules 16, LEDs may be configured to emit multiple colors such that the different colors are mixed within modules 16 thereby permitting additional control of the video or images displayed.

In one embodiment, modules 16 may be powered by individual batteries housed with LEDs or other light sources. In another embodiment, LED can have a battery power source and another LED can use the battery as a power source by having wires carrying power from other LEDs.

Another embodiment includes OLEDs as LEDs. OLEDs may reduce power requirements and permit longer operation on the same charge. OLEDs may permit modules 16 to run on the same charge for a long period of time, for example, by providing power to the OLEDs and then disconnecting the power source from the OLEDs, and then displaying the system.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A video display system comprising:
a substantially horizontally positioned activity area;
a plurality of modules operatively associated with the activity area and being arranged to form a display area, each of the modules including at least one light source; and
wherein the modules cooperatively display light to display at least one of video and images.

2. The system of claim 1, wherein the modules include light sources selected from the group consisting of light emitting diodes, organic light emitting diodes, polymer light emitting diodes, electroluminescent lights and combinations thereof.

3. The system of claim 1, wherein the activity area includes a substantially transparent shield overlying the modules.

4. The system of claim 1, wherein the modules are positioned in apertures formed in the activity area.

5. The system of claim 4, wherein the modules include a substantially transparent cover configured to resemble the surrounding surface of the activity area when the system is not in operation.

6. The system of claim 5, wherein the covers are positioned substantially flush or recessed with respect to a surrounding surface of the activity area.

7. The system of claim 6, wherein a substantially transparent shield overlies at least a portion of the activity area.

8. The system of claim 7, wherein the display area includes a region that is positioned above at least a portion of the activity area.

9. The system of claim 8, wherein the region at least partially surrounds the activity area.

10. The system of claim 1, wherein the activity area is associated with a public performance.

11. The system of claim 10, wherein the public performance is associated with and selected from the group consisting of athletic performances, cultural performances, entertainment performances and combinations thereof.

12. The system of claim 1, wherein the activity area is portable and/or re-usable.

13. A method of displaying video comprising:
providing a video display system comprising:
a substantially horizontally positioned activity area;
a plurality of modules associated with the activity area and being arranged to form a display area, each of the modules including at least one light source; and
cooperatively displaying light with the modules to display at least one of video and images.

14. The method of claim 13, wherein the modules include light sources selected from the group consisting of light emitting diodes, organic light emitting diodes, polymer light emitting diodes, electroluminescent lights and combinations thereof.

15. The method of claim 13, wherein the activity area includes a transparent shield overlying the modules.

16. The method of claim 13, wherein the modules are positioned in apertures formed in the activity area.

17. The method of claim 16, wherein the modules include a substantially transparent cover configured to resemble the surrounding surface of the activity are when the system is not in operation.

18. The method of claim 16, wherein the covers are positioned substantially flush or recessed with respect to a surrounding surface of the activity area.

19. The method of claim 18, wherein a substantially transparent shield overlies at least a portion of the activity area.

20. The method of claim 13, wherein the activity area is associated with a public performance selected from the group consisting of athletic performances, cultural performances, entertainment performances and combinations thereof.
